(19) United States
(12) Patent Application Publication
(10) Pub. No.: US 2002/0033466 A1
(43) Pub. Date: Mar. 21, 2002

(54) Firefighting foam composition

(76) Inventors: Daniel J. Shaffer, Reading, PA (US); Robert E. Gensemer, Denver, PA (US)

Correspondence Address: WILLIAM H. MURRAY, DUANE MORRIS & HECKSCHER LLP, ONE LIBERTY PLACE, PHILADELPHIA, PA, 19103-7396, US

(21) Appl. No.: 09/758,879

(22) Filed: Jan. 11, 2001

Related U.S. Application Data
(60) Provisional application No. 60/184,535, filed on Feb. 24, 2000.

(51) Int. Cl. A62D 1/00

(52) U.S. Cl. 252/3

(57) ABSTRACT

A method of preparing a stable firefighting foam composition is disclosed. The method comprises combining effective amounts of a) the product of water and an alkali metal alkyl sulfate, followed by b) a fluorinated polymer, to form a final, stable mixture of materials, the foam composition being distributable on a fire.

### CROSS REFERENCE TO RELATED APPLICATION

This application claims the priority of Provisional Patent Application Ser. No. 60/184,535, filed Feb. 24, 2000.

### BACKGROUND OF THE INVENTION

Firefighting foam concentrates are mixtures of foaming agents, solvents and other additives. These concentrates are intended to be mixed with water usually at either a 3% or 6% (i.e., full strength) concentration; the resulting solution is then foamed by mechanical means and the foam is projected onto the surface of a burning liquid.

A particular class of firefighting foam concentrates is known as an aqueous film-forming foam (AFFF or AF³) AFFF concentrates have the quality of being able to spread an aqueous film on the surface of hydrocarbon liquids, enhancing the speed of extinguishment. This is made possible by the perfluoroalkyl surfactants contained in the AFFF. These surfactants produce very low surface tension values in solution (15-20 dynes cm⁻¹) which permit the solution to spread on the surface of the hydrocarbon liquids.

AFFF foams are not effective on water soluble fuels, such as alcohols and the lower ketones and esters, as the foam is dissolved and destroyed by the fuel. There is a sub-class of AFFF foam concentrates known as alcohol resistant AFFF (ARAFFF or ARAF³). ARAFFF concentrates contain a water soluble polymer that precipitates on contact with a water soluble fuel, providing a protective layer between the fuel and the foam. ARAFFF foams are effective on both hydrocarbons and water soluble fuels.

Typical AFFF concentrates contain one or more perfluoroalkyl surfactants which may be anionic, cationic, nonionic or amphoteric, one or more non-fluorinated surfactants which may be anionic, cationic, amphoteric or nonionic, solvents such as glycols and/or glycol ethers and minor additives such as chelating agents, pH buffers, corrosion inhibitors and the like. Such compositions are known in the art.

ARAFFF concentrates are essentially the same as AFFF'S, with only the addition of a water soluble polymer. These compositions are disclosed in U.S. Pat. Nos. 4,060,489, 4,149,599 and 4,387,032.

We have unexpectedly discovered that a particular concentrated blend of chemicals provides the basic components of film forming foams for firefighting, which may then be diluted to formulate both concentrated, as well as full strength firefighting foam products.

### SUMMARY OF THE INVENTION

The firefighting compositions of the present invention comprise stable, biodegradable mixtures of an alkali metal alkyl sulfate, a fluorinated polymer, and water, combined in such a way so as to achieve maximum stability of the resulting firefighting formulation. The composition is blended by combining effective amounts of a) the product of water and an alkali metal sulfate, followed by b) a fluorinated polymer, to form a stable mixture of materials.

### DESCRIPTION OF THE PREFERRED EMBODIMENTS

The present invention provides an improvement over previous firefighting formulations and applications techniques. It has been discovered that a particular concentrated blend of chemicals provides the basic components of film forming foams for firefighting, which may then be diluted to formulate both concentrated, as well as full strength firefighting foam products.

In its most basic form, the composition of the present invention comprises a soluent (organic solvent), a surfactant, and a film forming agent. The end product produces a concentrate from which other firefighting foams, both in concentrate and full strength formulations, are derived.

In a preferred embodiment, the composition of the present invention (Product A) is as follows:

| Product A | Approximate Weight Percentages |
|---|---|
| Sodium Octyl Sulfate | 20-30% |
| Fluorinated Polymer (telomerized) | 4-10% |
| Water | 10-20% |

Note that the above formula refers to sodium octyl sulfate as a total percent of active ions in the concentrated formula; the fluorinated polymers are expressed as a percent of the total concentrated formula, and may be, e.g., either single or multiple carbon chain formulations of fluorinated polymers, more specific details of which may be found in U.S. Pat. No. 5,207,932 and WO 96/33777, herein incorporated by reference. In a particularly preferred embodiment of the present invention, the composition is blended in the following order: 1) water, followed by 2) sodium octyl sulfate, followed by 3) fluorinated polymer. This particular blend order promotes maximum stability. The present invention thus provides an effective base formula for film forming capabilities and contact extinguishment.

The biodegradability of a stock solution of the composition of the present invention in an aquatic environment was determined. Biodegradation is defined as the ratio of the biochemical oxygen demand (BOD) within 28 days to either the theoretical oxygen demand (ThOD) or the chemical oxygen demand (COD). The dissolved oxygen (DO) measurements and calculated BOD values for the test substance (Product A) and reference material (sodium acetate) are shown in Table 1, below.

TABLE 1
Dissolved Oxygen Concentration and Biochemical Oxygen Demand

| | Incubation period | | | | |
|---|---|---|---|---|---|
| | Day 0 | Day 7 | Day 14 | Day 21 | Day 28 |
| Incubator temperature | 20.7 | 20.4 | 20.5 | 22.5 | 22.1 |
| (° C.) | | | | | |
| Blank DO (mg/l) | 8.88 | 8.74 | 8.59 | 8.51 | 8.38 |
| Test substance DO (mg/l) | 8.85 | 8.48 | 8.24 | 8.09 | 8.04 |
| BOD value (mg O₂/g) | — | 115 | 160 | 195 | 155 |
| Reference material | 8.87 | 7.63 | 7.34 | 7.24 | 7.15 |
| DO (mg/l) | | | | | |
| BOD value (mg O₂/g) | — | 550 | 620 | 630 | 610 |

The resulting COD value was 242,000 mg O₂/l (specific gravity 1.02), equivalent to 237 mg O₂/g material.

In the testing of the present invention, degradation was followed by weekly measurements of the dissolved oxygen concentration for a 28 day period. The biochemical oxygen demand (BOD) was calculated from the decrease in the dissolved oxygen concentration, compared with a blank containing no test substance.

A stock solution of the material of the present invention in deionized water was prepared, and added to dilution water in order to obtain the required test concentration. Replicate standard BOD bottles were filled with the test solution. A set of replicate bottles was prepared with dilution water only, for the determination of “blank” losses. Initial dissolved oxygen (DO) concentrations were measured, using a dissolved oxygen meter. The bottles were then incubated in the dark at 20° C. for the duration of the test period. Additional measurements of dissolved oxygen concentration were made after 7, 14, 21 and 28 days.

The percent degradation values for the material of the present invention and reference material are shown in Table 2 below.

TABLE 2
Percent Degradation

| | Incubation period | | | |
|---|---|---|---|---|
| | Day 7 | Day 14 | Day 21 | Day 28 |
| Product A | 48.5 | 67.5 | 82.3 | 65.4 |
| Reference material | 70.5 | 79.5 | 80.8 | 78.2 |

Note that the material of the present invention gave a maximum value of 82.3 percent degradation.

The non-corrosive nature of the materials of the present invention was also tested. Four metal coupons were immersed in glass beakers containing a 600 ml solution of 90 percent Product A concentrate and 10% synthetic seawater. Watch glass covers were placed over the beakers in order to deter evaporation. The 600 ml glass beakers and watch glasses were cleaned and rinsed with distilled water, and allowed to air dry. The metal coupons were cleaned with acetone and allowed to air dry. After weighing, the coupons were placed in the 90/10 solutions for 60 days. After 60 days, the coupons were removed from the solutions and weighed. Prior to weighing the steel coupon, all oxidation scale was removed from the particular coupon. No scale was present on any other coupon. The results are shown in Table 3, below.

TABLE 3

| Metal Coupon Type | Weight at start | Weight at end | Weight loss |
|---|---|---|---|
| Bronze | 38.40 grams | 38.40 grams | 0.0 grams |
| Steel | 11.75 grams | 11.725 grams | 0.025 grams |
| Copper-nickel | 13.80 grams | 13.79 grams | 0.01 grams |
| Nickel-copper | 13.20 grams | 13.20 grams | 0.0 grams |

Note that in all cases, there was no evidence of pitting on any of the coupons, thus demonstrating the non-corrosive nature of the materials of the present invention. The treatments of the present invention are most effective at concentration of about 0.1-6%, with a concentration of about 3% preferred.

While this invention has been described with respect to particular embodiments thereof, it is apparent that numerous other forms and modifications of this invention will be obvious to those skilled in the art. The appended claims and this invention generally should be construed to cover all such obvious forms and modifications which are within the true spirit and scope of the present invention.

We claim:

1. A method of preparing a stable firefighting foam composition comprising combining effective amounts of a) the product of water and an alkali metal alkyl sulfate, followed by b) a fluorinated polymer, to form a final, stable mixture of materials, said foam composition being distributable on a fire.

2. The method as recited in claim 1 wherein said alkali metal alkyl sulfate is sodium octyl sulfate.

3. The method as recited in claim 1, wherein about 10-20 weight percent of water is present in the final mixture.

4. The method as recited in claim 1, wherein about 20-30 weight percent of sodium octyl sulfate is present in the final mixture.

5. The method as recited in claim 1, wherein about 4-10 weight percent of fluorinated polymer is present in the final mixture.
